(19) United States
(12) Patent Application Publication
(10) Pub. No.: US 2023/0031236 A1
(43) Pub. Date: Feb. 2, 2023

(54) TRANSMISSION OF DATA PACKETS

(71) Applicant: B&R INDUSTRIAL AUTOMATION GMBH, Eggelsberg (AT)

(72) Inventor: Dietmar BRUCKNER, Lamprechtshausen (AT)

(73) Assignee: B&R INDUSTRIAL AUTOMATION GMBH, Eggelsberg (AT)

(21) Appl. No.: 17/638,433

(22) PCT Filed: Aug. 25, 2020
(86) PCT No.: PCT/EP2020/073721

§ 371 Date: Feb. 25, 2022

(30) Foreign Application Priority Data
Aug. 27, 2019 (AT) A50740/2019

(51) Int. Cl. H04L 12/46; H04L 47/28; H04L 47/2441

(52) U.S. Cl. CPC H04L 12/4625; H04L 47/28; H04L 47/2441

(57) ABSTRACT

The aim is to transmit a data packet from an ethernet component, which is in an ethernet network, to an industrial communication network in a mixed network. An industrial communication network configured according to the standards of the IEEE 802.1 TSN working group is used, and at least one guarantee defined in the standards of the IEEE 802.1 TSN working group is assigned for the data packet in that a frame which contains the data packet is identified in the industrial communication network configured according to the standards of the IEEE 802.1 TSN working group by a TSN bridge and converted into a TSN stream which contains the data packet, and the data packet is transmitted to a TSN component in the TSN stream.

The present invention relates to a method for transmitting a, preferably cyclic, data packet from an ethernet component, which is arranged in an ethernet network within a mixed network, to a TSN component, which is arranged in an industrial communication network configured according to the standards of the IEEE 802.1 TSN working group.

A pure ethernet network, which consists exclusively of standard ethernet components, is not deterministic, meaning that no time guarantees can be assigned for sent/received data packets—even if all existing quality-of-service mechanisms are exhausted. In industrial communication networks, on the other hand, data packets can be transmitted cyclically and with guarantees. To make this possible, industrial communication networks are usually built up from special industrial ethernet components, i.e. special industrial ethernet software stacks and special industrial ethernet hardware. Industrial communication networks are usually characterized by low bit error rates, as well as special frame formats and the precisely timed sending of cyclic frames.

Endpoints and controllers represent components of a network, wherein an endpoint can only receive data packets via one connection and a controller can receive data packets via several connections. A bridge is also called a switch and is used to connect components of a network. An edge bridge is used to connect a network (e.g. an industrial communication network) to a second network (e.g. a standard ethernet network). Bridges can thus represent pure network infrastructure devices, but they can also be used as endpoints or controllers as bridged endpoints or bridged controllers, which means that they can also be used to connect other components.

Special industrial ethernet components, in particular special industrial ethernet hardware, are of course more expensive than standard ethernet components. For this reason, instead of a pure industrial communication network, a mixed network can be provided which comprises an industrial communication network and a (standard) ethernet network. For this purpose, ethernet components can be connected to the industrial communication network via a gateway. However, the (standard) ethernet components do not support any functions necessary for cyclic data traffic for sent/received data packets, for example assigning guarantees, in particular time guarantees. In such a mixed network, without special precautions, it cannot therefore be foreseen how long a data packet sent from a standard ethernet component will be travelling in the mixed network. It is also impossible to foresee whether a data packet will be lost, for example due to a bridge buffer overflow.

Well-known industrial communication networks with special industrial ethernet hardware include PROFINET IRT, POWERLINK, EtherCAT, SERCOS, etc. Such industrial communication networks each have special mechanisms in order to implement mixed networks. In the context of these mechanisms, however, the introduction of non-real-time traffic is fundamentally restricted in order not to endanger real-time capability.

Ethernet/IP and Profinet/IO, on the other hand, represent industrial communication networks that are built up from standard ethernet components. As a result, however, these industrial communication networks have longer cycle times and are less robust with respect to non-real-time traffic, since real-time traffic and non-real-time traffic cannot be differentiated on the basis of their associated frames and are therefore treated in the same way by the bridges. It is therefore possible that real-time traffic is displaced by non-real-time traffic. In particular, when there is a high occurrence of non-real-time traffic, part of the real-time traffic can be shifted to a subsequent cycle. The receiver thus does not receive any data packets at least in one cycle and switches to an error mode and/or extrapolates the previously received data packets. In one of the following cycles, the receiver then receives a plurality of data packets. These multiple data packets must in turn be treated specially. If a small proportion of non-real-time traffic is provided, the problem mentioned seldom occurs, of course. Choosing such a long cycle time that the bandwidth required for real-time traffic is relatively small can serve to increase robustness. At best, this measure does not result in any shifting of individual frames into the next cycle.

In order to even allow cyclic data traffic in industrial communication networks based on standard ethernet components, information about the runtime of the sent cyclic data packets must be provided. A well-known way to do this is to use “network calculus.” “Network calculus” is a common method for calculating or estimating latencies in a non-real-time capable network. This allows limit values for the runtime of the data packets to be specified, with which the bandwidths required for transmitting a data packet can be calculated. This information is selected according to statistical range estimates. Hence, networks using this method must be generously oversized. The correct sizing of the network is therefore heavily dependent on the experience of the network engineer, since if the planning is inadequate, the network cannot function or can only function to a limited extent and/or compliance with the necessary cycle time cannot be guaranteed, which means that data packets can be lost.

It is therefore an object of the present invention to provide a method which allows data packets to be sent between standard ethernet components in an ethernet network and components in an industrial communication network, wherein better real-time capability is ensured.

This object is achieved according to the invention by a method for transmitting a, preferably cyclic, data packet from an ethernet component, which is arranged in an ethernet network within a mixed network, to a TSN component, which is arranged in an industrial communication network configured according to the standards of the IEEE 802.1 TSN working group within the mixed network, wherein at least one guarantee defined in the standards of the IEEE 802.1 TSN working group is assigned for the data packet in that a frame F1 which contains the data packet is identified in the industrial communication network configured according to the standards of the IEEE 802.1 TSN working group by a TSN bridge and converted into a TSN stream which contains the data packet, and the data packet is transmitted to the TSN component in the TSN stream.

According to the invention, the industrial communication network is thus configured according to the standards of the IEEE 802.1 TSN working group, which allows guarantees to be assigned, for example for cyclic data packets. The industrial communication network, which is configured according to the standards of the IEEE 802.1 TSN working group, is referred to as a TSN network for the sake of simplicity. The components in the TSN network are referred to as TSN components. The streams configured in the standards of the IEEE 802.1 TSN working group are referred to as TSN streams. The part of the network outside of the TSN network is commonly referred to as the ethernet network. Components that are not in the TSN network (or other industrial communication networks) but in the (ethernet) network are referred to as ethernet components. Ethernet frames are referred to as frames for the sake of simplicity.

If a frame containing a data packet is sent from the ethernet network to the TSN network without further treatment, this is done by definition as a “best effort,” which means that no guarantee can be assigned for the data packet. For this reason, TSN streams are used according to the invention, thereby improving communication between the TSN components and the ethernet components. In a TSN stream, a data packet is transmitted from a TSN component as a sender (talker) via one or more appropriately configured TSN bridges to one or more TSN components as receivers (listeners).

Using TSN streams has the advantage of simpler estimation of the required bandwidth for the transmission of the data packets in the TSN network, since the bandwidth of unscheduled time windows and/or the free bandwidth of the TSN components is known. This means that the free bandwidth can be planned for further TSN streams by providing further time windows for TSN streams, as described in the TSN configuration options introduced in IEEE 802.1Qcc. According to the invention, the further TSN streams transport further data packets.

If, for example, a network guarantee of a TSN stream S1 is exceeded because it requires too much bandwidth, another guaranteed TSN stream is not affected. If non-reserved bandwidth is free on the TSN bridge, this can be made available (at the expense of “best effort” traffic).

In principle, the entire network could also be built up exclusively from TSN components, which means that there is only one global TSN network. However, since the TSN functions of the TSN components are only required for high- performance applications that only comprise a part of the tasks, an only partial structure using TSN components is advantageous. In particular, such a structure as a mixed network is significantly more cost-effective than a pure TSN network.

In a mixed network, ethernet components thus serve as feeders to the TSN network. Communication within the ethernet network (and outside of the TSN network) can take place in a known manner by sending frames with data packets. However, outside of the TSN network, no guarantees, rather at best estimates, can be assigned for the respective data packet. This also applies to frames with data packets that are sent to the TSN network before they arrive in the TSN network and are converted into TSN streams.

In the ethernet network (outside of the TSN network), appropriate measures such as isolation, oversizing and “network calculus” can also be provided. Isolation generally refers to the use of individual subnetworks through which only part of the data traffic is routed. As a result, the potential disruptive influences for real-time traffic due to non-real-time traffic that occurs are lower. For an ethernet network with isolation, of course, more network infrastructure, i.e. more bridges and cabling, is required than for an ethernet network without isolation. However, using such measures in the ethernet network (outside of the TSN network) is still less costly than operating a pure TSN network.

A further advantage of a mixed network is that additional ethernet components can be connected to the ethernet network as part of the mixed network without influencing the already existing TSN streams, since the TSN streams only exist in the TSN network as part of the mixed network.

A mixed network can also be set up in a simple manner, since industrial ethernet components are often provided with a standard ethernet connection and the TSN network can easily be expanded to include additional ethernet components, creating an “ethernet island” in the TSN network. The TSN network is an extension of an ethernet network and is therefore fully backwards compatible. However, the additional ethernet components can influence existing “best effort” frames.

The frame is preferably identified in accordance with the IEEE 802.1CB standard. The TSN stream in the TSN network can thus be shaped with the time-aware shaper of the IEEE 802.1Qbv TSN standard. This is particularly advantageous if, for example, a reception time or a bandwidth is assigned as a guarantee.

In principle, cyclic process data, audio/video data and other streaming services, configurations, network traces, firmware downloads etc. can be sent as data packets. In order to be able to correctly recognize the frames of these data packets when entering the TSN network, a stream identification function, as defined in the IEEE 802.1CB standard, can be used. Four stream identification functions are defined in the 802.1CB standard, wherein access to the header information from higher protocols (IP, UDP, TCP, OPC UA etc.) is also possible.

The credit-based shaper (from IEEE 802.1Q) or the asynchronous traffic shaper from IEEE 802.1Qcr can also be used for guaranteed bandwidth, burst capability and/or latency. These egress features (which “shape” the traffic at the exit of a bridge) are very often supported by ingress policing (IEEE 802.1Qci) in order to sort out incorrectly “shaped” or sent TSN frames at the entrance of a bridge.

When the frame arrives in the industrial communication network configured according to the standards of the IEEE 802.1 TSN working group, the frame is preferably identified by a TSN edge bridge, converted into the TSN stream and transmitted to the TSN component. A TSN edge bridge is a TSN bridge, which is also connected to a standard ethernet component. Alternatively, the frame can also be sent on by a TSN edge bridge as a “best effort” along the communication link to other TSN bridges and only converted into the TSN stream by a subsequent TSN bridge and then forwarded as such.

When the frame is converted into the TSN stream, an ethernet header of the frame is preferably replaced by a TSN header, which is particularly preferably carried out by means of a retagging function according to the IEEE 802.1Qci standard.

The TSN header then comprises a stream address instead of a (unicast) destination MAC address used by ethernet. The frame which contains the data packet can therefore be identified on the one hand based on an ethernet header and on the other hand the ethernet header of the original frame can be replaced by a TSN header during the subsequent conversion into the TSN stream.

A frequently used function in managed ethernet networks are virtual LANs (VLANs), wherein each ethernet component can become a member of one or more VLANs. The frames sent between ethernet components of a VLAN are tagged with a corresponding tag (tagged frames). The network infrastructure ensures that these frames are not seen by ethernet components that are members of other VLANs—not even if they are sent as a broadcast. The TSN streams in the TSN network can be seen as an extension of this concept, since subnetworks are encapsulated with VLANs and concrete communication relationships are encapsulated with TSN streams. Therefore, the VLAN field can be used as part of the stream address of TSN streams. A TSN stream prescribes a VLAN tag, which is a fixed part of the stream address. A retagging function as described in the IEEE 802.1Qci standard can be used for this purpose. The identified frame thus receives a new header with stream ID, which means that the data packet is treated as a TSN stream and not as unspecified “best effort” traffic.

The standards of the IEEE 802.1 TSN working group require a VLAN tag and define a DMAC+VLAN tag as the stream address (as one option). This stream address comprises a total of 10 bytes and is overwritten during retagging. The other header fields (in this case the source MAC address and ethertype preferably remain unchanged). The ethernet standard only optionally allows the 4-byte VLAN tag in which VLANs and priorities can be defined. If this VLAN tag was not available, it can be inserted during retagging, whereby the frame is lengthened accordingly.

A minimum bandwidth of the TSN stream and/or a maximum latency of the TSN stream and/or a defined burst capability of the TSN stream and/or a defined reception time of the TSN stream is preferably assigned as a guarantee. This is not possible in industrial ethernet networks based on standard ethernet components and is therefore made possible by using a TSN network as an industrial communication network.

A burst is the transmission of a large quantity of data as quickly as possible. Without the appropriate precautions, however, it is very likely that individual frames of the burst will collide with other traffic in the network. In a TSN network, the IEEE 802.1 TSN Qav standard can be used, which defines the so-called credit-based shaper for a burst. In a TSN network, a sender can save credits by “resting” or “not sending,” which it must then spend when sending TSN frames. This defines the maximum size of a possible burst. If the sender has no more credits, it must wait after each frame until it has enough credits for the next frame. This will spread its frames fairly evenly over time.

The standards of the IEEE 802.1 TSN working group comprise various traffic shaping mechanisms. The (802.1) Qbv standard can, for example, assign time guarantees. The (802.1) Qav standard can also be used to reserve latencies and bandwidths. The (802.1) Qci standard can in turn be used to restrict bandwidths. Of course, all (relevant) other standards contained/referenced in IEEE 802.1 TSN can also be used for the implementation of traffic guarantees (such as Qch, Qcr etc.).

The guarantees can be assigned for cyclically sent data packets, but also for “irregular” (sporadically sent) data packets such as video streams or Internet downloads, etc. The content of the data packet is not relevant for assigning guarantees, although the choice of configuration can of course be based on the assumed requirements of the data packets.

If cyclic process data are sent as data packets, guarantees are preferably assigned for the reception time or for the latency. In the case of audio/video data or configuration data as data packets, guarantees are preferably assigned for the bandwidth. In the case of traces and/or downloads as data packets, guarantees are preferably assigned for burst capability and latency.

The standards of the IEEE 802.1 TSN working group define, among other things, shaping mechanisms for real-time, bandwidth, burst capability and latency. TSN shaping mechanisms are therefore preferably used to assign guarantees for the TSN stream. This means that any guarantees that are defined in the standards of the IEEE 802.1 TSN working group can be assigned. This can be done by carrying out a shaper configuration in the TSN bridge, which converts to the TSN stream. Furthermore, the shaper configuration is carried out in all other TSN bridges over which the TSN stream is routed.

A reception time can be assigned as a guarantee by transmitting the data packet to the TSN component in a TSN stream during a specified time window of a cycle. For the sending of cyclic data with a guaranteed reception time, time windows are configured exclusively for this TSN stream in the TSN network for each TSN bridge over which the TSN stream is routed. If the sender (talker) also guarantees its transmission time for each cycle, the transmission of the TSN stream can be optimized, since the time windows in the TSN network can be very close and without large buffers.

If a shaping mechanism is used in a TSN network at the same time as “best effort” traffic or a plurality of shaping mechanisms, then this is generally referred to as “converged,” which results in a so-called “converged network.” In a “converged network,” different types of data traffic with different requirements (runtime, bandwidth, burst capability, etc.) are mapped simultaneously on a network infrastructure.

If a plurality of traffic shaping mechanisms are used in a TSN network, not all types of traffic are usually active with the full reserved bandwidth. Thus, for optimization purposes, unused bandwidth can be shared by one shaper with another shaper. TSN streams with lower priority can also be interrupted by TSN streams with higher priority, if this allows the TSN streams with lower priority to meet their guarantees (as described in IEEE 802.1Qbu and IEEE 802.3br).

Preferably, when a data packet is transmitted from the TSN component located in the industrial communication network configured according to the standards of the IEEE 802.1 TSN working group to an ethernet component located in the ethernet network outside of the industrial communication network configured according to the standards of the IEEE 802.1 TSN working group, a TSN stream which contains the data packet is converted by a TSN bridge into a frame which contains the data packet and the data packet is transmitted in the frame to the ethernet component.

When the TSN stream is converted into the frame, the TSN header of the TSN stream can be replaced by an ethernet header, preferably by means of a retagging function according to the IEEE 802.1Qci standard.

When the TSN stream is converted into the frame, the TSN header of the TSN stream can be removed from the VLAN tag or the TSN header of the TSN stream can be used for the frame.

If the VLAN tag is deleted, the features of the VLAN tag, i.e. the definition of priorities of frames and the configuration of virtual networks, are of course lost. This means that only components that have configured the same VLAN can send frames to one another.

If the TSN header is still used, the TSN header is interpreted as a frame header by unconfigured ethernet components. By convention, the multicast bit is set in the TSN header, which means that the frame is sent everywhere in the ethernet network. The respective receiver must therefore be configured in such a way that it receives the multicast address. Furthermore, the ethernet network is more heavily loaded with such multicast frames.

If the TSN stream is sent unchanged to the ethernet network, the multicast destination MAC address used by the TSN stream is interpreted as a broadcast and the bridges of the ethernet network send the frame to all ethernet components. However, doing this will flood part of the network with unnecessary data. Therefore, it is fundamentally advantageous to convert the TSN stream into a frame.

Advantageously, when transmitting a TSN stream from the TSN component located in the industrial communication network to an ethernet component located in the ethernet network outside of the industrial communication network, the TSN stream can be converted into a frame by a TSN bridge.

When leaving the industrial communication network configured according to the standards of the IEEE 802.1 TSN working group, the TSN stream is preferably converted by a TSN edge bridge into the frame which contains the data packet.

Instead of the TSN edge bridge, a TSN bridge located further inside the TSN network can take over the conversion into a frame. In this case, the frame is sent on the communication link from the converting TSN bridge to the TSN edge bridge as a “best effort,” although it is actually still in the TSN network.

The standards of the IEEE 802.1 TSN working group comprise in particular the IEEE 802.1Q-2018 standard, which describes the TSN functions. Furthermore, the standards of the IEEE 802.1 TSN working group comprise the IEEE 802.1CB-2017 standard.

Until 2018, the IEEE 802.1Qbv-2015, IEEE 802.1Qci-2017, IEEE 802.1Qch-2017 and IEEE 802.1Qbu-2016 standards were amendments to the IEEE.802.1Q-2014 standard and thus represented independent standards and were included in the IEEE 802.1Q-2018 standard. IEEE 802.1Qav-2009 was already included in the standard in IEEE.802.1Q-2014.

The IEEE 802.1Qcc-2018 standard was only published in 2018 and is therefore an amendment to the IEEE 802.1Q-2018 standard.

The IEEE 802.1Qav standard was included in the IEEE 802.1Qav-2009 standard and is now also included in the IEEE 802.1Q-2018 standard.

The IEEE 802.1Qcr project has not yet been published as a standard at the time the patent application in question is submitted and has the project number IEEE P802.1Qcr.

The IEEE Std. 802.3br-2016 standard is an amendment to the IEEE Std. 802.3-2015 standard and now included in the IEEE 802.3-2018 standard.

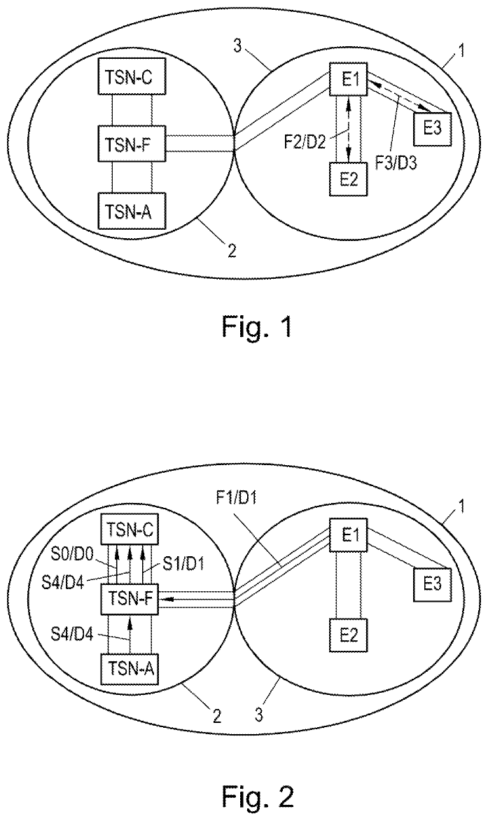

In the following, the present invention shall be described in greater detail with reference to FIGS. 1 to 3, which show exemplary, schematic and non-limiting advantageous embodiments of the invention. In the drawings:

FIG. 1 shows an ethernet network and an embedded TSN network,

FIG. 2 shows a conversion of a frame into a TSN stream,

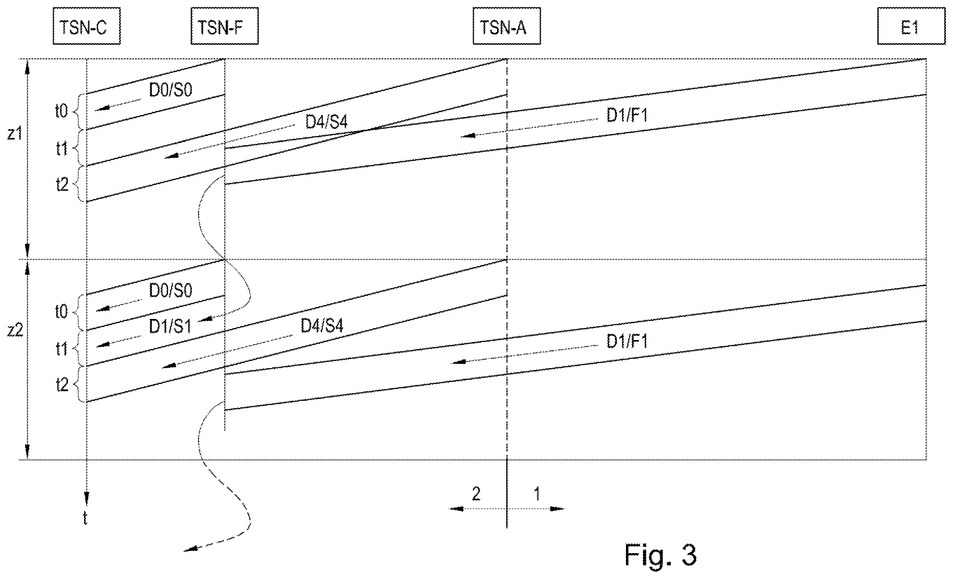

FIG. 3 shows a reception time as a time guarantee.

FIG. 1 shows a mixed network 1 which comprises an ethernet network 3. The ethernet network 3 in turn comprises a number of ethernet components E1, E2, E3. Network components that are configured according to IEEE 802.10 (and the other commonly used standards for ethernet bridges) but not according to the standards of the IEEE 802.1 TSN working group are referred to as ethernet components E1, E2 E3. For example, an ethernet controller is provided in the ethernet network 3 as the ethernet component E1, which is connected to an ethernet field device as the second ethernet component E2 and to an ethernet printer as the third ethernet component E3. The ethernet controller E1 and the ethernet field device E2 can process cyclic data traffic, but the ethernet printer E3 cannot. However, the applicative function of the ethernet components E1, E2, E3 is not decisive for the function of the invention. The ethernet controller E1, ethernet field device E2 and ethernet printer E3 are therefore generally referred to as ethernet components E1, E2, E3. The communication connections between the ethernet components E1, E2, E3 are shown as bars in FIGS. 1 and 2 and connect ports of the respective ethernet components E1, E2, E3.

In the ethernet network 3, frames F2, F3 are sent between the ethernet components E1, E2, E3, each of which contains data packets D2, D3. The ethernet component E2 communicates via a connecting communication link with the ethernet component E1 (and vice versa) via a data packet D2 contained in the frame F2. Furthermore, the ethernet component E3 communicates via a connecting communication link with the ethernet component E1 (and vice versa) via a data packet D3 contained in the frame F3. This communication is indicated in FIG. 1 by the arrows along the respective communication connections between the ethernet components E1, E2, E3. Within the ethernet network 3, the data packets D2, D3 can only be sent in frames F2, F3 and thus without assigning guarantees.

The ethernet components E1, E2, E3 can be managed or also unmanaged. Unmanaged ethernet components E1, E2, E3 can be connected to the ethernet network 3 in a simple manner (plug-and-play), but offer no option for configuration or management. An unmanaged ethernet component E1, E2, E3 independently learns the target address of a further ethernet component E1, E2, E3 that can be reached via a port by evaluating source addresses of frames F2, F3 that are sent from this further ethernet component E1, E2, E3. If a target address of a frame F2, F3 is still unknown (because no frame F2, F3 has yet been received from the further ethernet component E1, E2, E3), the frame F2, F3 is forwarded to all ports and thus to all ethernet components E1, E2, E3, which is referred to as flooding. Managed ethernet components E1, E2, E3, on the other hand, can be configured, managed and/or monitored, for example, by an external device. For example, an address table can be configured or the ethernet network 3 can be divided into independent segments by means of VLANs. Within the scope of the present invention, managed and/or unmanaged ethernet components E1, E2 E3 and/or VLANs can be used.

The ethernet components E1, E2, E3 and TSN components TSN-A, TSN-F, TSN-C described in the context of the embodiment shown are able to generate and receive data packets and are also part of the network infrastructure with more than one port. In the IEEE nomenclature, they are bridged endpoints. Without loss of generality, however, all endpoint-specific statements also apply to endpoints with only one port and all network infrastructure-specific statements also apply to pure network infrastructure devices, i.e. pure bridges.

In addition to the ethernet network 3, the mixed network 1 comprises at least one industrial communication network, preferably with cyclic data traffic, which is configured according to the invention in such a way that functions according to the standards of the IEEE 802.1 TSN working group are supported. This part is referred to as a TSN network 2 in the following and can be surrounded by an ethernet network 3 as a “TSN island.” The TSN network 2 can also adjoin the ethernet network 3, as is shown in FIGS. 1 and 2. The TSN network 2 comprises the TSN components TSN-A, TSN-F and TSN-C, for example as field devices, wherein the TSN component TSN-F also serves as a TSN edge bridge. The communication links between the TSN components TSN-A, TSN-F, TSN-C are also shown as bars and connect the ports of the respective TSN components TSN-A, TSN-F, TSN-C. There is also a communication link in the mixed network 1 between the ethernet network 3 and the TSN network 2 in the form of a communication link between the ethernet component E1 and the TSN component TSN-C via the TSN edge bridge TSN-F.

One or more further ethernet networks 3 and/or one or more further industrial networks, preferably with cyclic data traffic, could of course also be provided in the mixed network 1. These one or more further industrial networks can also be configured according to the standards of the IEEE 802.1 TSN working group and thus represent one or more TSN networks 2. Any industrial networks or TSN networks can adjoin other ethernet networks 3 and/or TSN networks 2 in the mixed network 1 and/or be surrounded by other ethernet networks 3 and/or TSN networks 2 as “TSN islands.”

If a data packet D2, D3 is sent in a frame F2, F3 from an ethernet component E1, E2, E3 to a further ethernet component E1, E2, E3, the said frame F2, F3 can also be routed through the TSN network 2 instead of a direct transmission via the direct communication link. However, there would be no conversion into a TSN stream and no guarantees would be assigned.

Within a TSN network 2, the transmission of TSN data packets D0, D4 between the respective TSN components TSN-C, TSN-F, TSN-A can be configured with known TSN traffic shaping mechanisms. For example, the TSN component TSN-F can send a TSN stream S0 with a data packet D0 to the TSN component TSN-C (as indicated in FIG. 2) and vice versa (not shown in FIG. 2). Guarantees can be assigned for the transmission of the data packet D0, for example a maximum required bandwidth, a maximum latency, a guaranteed transmission time and/or reception time etc. The maximum available guarantees must of course be subordinate to the boundary conditions of the TSN components TSN-C, TSN-F, TSN-A, such as network load occurring on the transmitter side, forwarding latencies, available bandwidth or data transmission rate (e.g. gigabit) etc., in the TSN network 2. This check is a task of the configuration tool and is not relevant to the invention.

Furthermore, in FIG. 2, a further TSN stream S4 with a data packet D4 is sent from the TSN component TSN-A via the TSN component TSN-F to the TSN component TSN-C by way of example. The configuration of the TSN network 2 ensures that the TSN stream S4 and the TSN stream S0 can be sent from the TSN component TSN-F to the TSN component TSN-C. In this case, neither the TSN stream S4 interferes with the TSN stream S0, nor vice versa, although the same communication link is used. This is possible even if the further TSN stream S4 and the TSN stream S0 demand the same guarantees (reception time, bandwidth, latency, etc.).

If, on the other hand, a further frame was to coincide with an already provided frame F2, F3 within the ethernet network 3, i.e. if it were forwarded to the same port at the same time, the further frame would disrupt and delay the frame F2, F3, even if this does not take place via the same communication link. The jitter that occurs would result in the further frame being processed once and the intended frame F2, F3 being processed once. In return, the TSN network can configure exactly when which frame is to be forwarded and the forwarding is therefore always the same despite external jitter.

In FIG. 2, in addition to the TSN streams S0, S4, a data packet D1 is transmitted from the ethernet component E1 via the TSN component TSN-F (as a TSN edge bridge) to the TSN component TSN-C. This arrives approximately at the same time as the transmission of the TSN streams S0, S4 at the TSN component TSN-F. In contrast to the transmission of a TSN stream S0, S4 from the TSN component TSN-F to the TSN component TSN-C, basically no time guarantee can be assigned for the transmission of a frame F1 itself. Depending on the arrival time, the frame F1 would be forwarded before the two TSN streams S0, S4 or afterwards. According to the invention, therefore, the frame F1, which contains the data packet D1, is identified in the TSN network 2 by a TSN bridge, which is carried out here by the TSN component TSN-F in the form of a TSN edge bridge. From this identification onwards, the necessary transmission properties of the data packet D1 to be transmitted are known, since these are preconfigured. After identification, the frame F1 is converted into a TSN stream S1 and processed accordingly in the TSN network 2. This conversion takes place, for example, by replacing the ethernet header of the frame F1 with a TSN header from the TSN stream S1 in accordance with the configuration. The TSN stream S1 is then sent from the TSN bridge (here TSN component TSN-F) to the addressed TSN component(s) (here TSN component TSN-C) via the communication links provided and treated in accordance with the configuration. This does not affect further data traffic (here in the form of TSN streams S0, S4 with data packets D0, D4) on the same communication link—in the converged network, the guarantees for all TSN streams S0, S1, S4 are met. In FIG. 2, only one communication connection from the TSN component TSN-F to the TSN component TSN-C serves as a communication link. Of course, the TSN stream S1 could also be routed via further communication links and TSN components.

The identification of the frame F1 and the conversion of the frame F1 into a TSN stream S1 can, as described in this embodiment, take place immediately upon arrival in the TSN network 2 at a TSN edge bridge (here on the TSN component TSN-F) of the TSN network 2.

Instead, however, in larger networks in particular, the frame F1 could also be forwarded by a TSN edge bridge first as a “best effort” and identified by one of the subsequent TSN bridges and converted into a TSN stream S1. This can be particularly advantageous if the configuration capacities of the TSN edge bridge are insufficient.

With the retagging method mentioned, all frames originating from the ethernet network 3 can be converted into TSN streams, provided that there is sufficient bandwidth in the TSN network 2.

If a frame with a data packet is sent into the TSN network 2 as a “best effort,” this is done without a guarantee, in particular without a time guarantee, provided that no conversion into a TSN stream takes place in the TSN network 2. The frame in question is then also treated as a frame after it has arrived in TSN network 2. No guarantees are assigned because no corresponding mechanisms have been configured. This can lead to the data packet arriving with unpredictable delay times. The more bandwidth is reserved for TSN streams S0, S1, S4 in the TSN network 2, the less bandwidth remains for frames, which means that the (ethernet) frames without conversion into TSN streams experience unpredictable delays in the TSN network 2 or can even be discarded entirely.

FIG. 3 shows some communication relationships within the mixed network 1. The TSN network 2, here in the form of the TSN components TSN-A, TSN-C and TSN-F, exemplified as field devices, is shown on the left-hand side. The ethernet network 3 is shown on the right-hand side, wherein only the ethernet component E1 is considered here as an example.

According to FIG. 2, in the TSN network 2, a data packet D0 is transmitted as a TSN stream S0 from the TSN component TSN-F to the TSN component TSN-C. Furthermore, a data packet D4 is transmitted as a TSN stream S4 from the TSN component TSN-A via the TSN component TSN-F to the TSN component TSN-F.

Since resources are appropriately kept free for the TSN streams S0, S4 in the TSN network 2, guarantees, in particular time guarantees, can be assigned for the TSN streams S0, S4.

To provide a time guarantee, artificial cycles z1, z2 with a cycle time (of 10 ms, for example) can be introduced as part of the configuration. In FIG. 3, two time cycles z1 z2 are shown along the time axis t. In the TSN network 2, individual time windows t0, t1, t2 are provided in each cycle z1, z2. The time window t0 is provided here for the TSN stream S0 with the data packet D0. The time window t2 is provided for the TSN stream S4 with the data packet D4. The time window t1 is provided for the TSN stream S1 and is discussed further below. A time guarantee is assigned for the TSN streams S0, S1, S4 by configuring an exclusive time window t0, t1, t2 for an associated TSN stream S0, S1, S4 for the communication link between the TSN components TSN-F and TSN-C in each cycle z1, z2. Only the reserved TSN stream S0, S1, S4 is forwarded in the respective time window t0, t1, t2. From this it can be determined when the respective TSN stream S0, S1, S4 and the data packet D0, D1, D4 it contains is received, thereby realizing a time guarantee.

For the TSN stream S0, the reception times for the TSN component TSN-C are guaranteed in the time window t0 of the respective cycle z1, z2 if the TSN component TSN-F can comply with the intended transmission times of the TSN stream S0. If the TSN component TSN-F sends the TSN stream S0 to the TSN component TSN-C at the intended transmission time, the TSN stream S0 is sent to the TSN component TSN-C in the same time window t0 of the current cycle z1, z2. In the TSN network 2, the corresponding bandwidth is kept free for the TSN stream S0 which contains the data packet D0 on the communication link between the TSN component TSN-F and the TSN component TSN-C. If the transmission time for a TSN stream S0 with the data packet D0 is adhered to, then this always arrives at the TSN component TSN-C in the same cycle z1, z2.

Due to an error in or an incorrect configuration of a TSN component TSN-A, TSN-F, TSN-C, the case may arise that the intended transmission time for the TSN network 2 internal TSN stream S0 is not adhered to. This means that no guarantee can be assigned for reception in the time window t0 of the current cycle z1. However, if at least the maximum size of the data packet D0 contained in the TSN stream S0 can be maintained, one cycle can be guaranteed as the maximum latency. The data packet D0 is buffered up to the time window t0 of the following cycle z2 and then sent in this time window t0. In this case, there is no guarantee for the time window t0 in the current cycle z1. However, a guarantee is therefore assigned for the time window t0 in the next cycle z2. The same applies to the TSN stream 54 with the data packet D4.

A data packet D1 is now sent from the ethernet component E1 to the TSN network 2 in a frame F1. The frame F1 is identified by the TSN component TSN F as a TSN (edge) bridge and converted into a TSN stream S1. The data packet D1 is sent to the TSN component TSN-C after the conversion of the frame F1 into the TSN stream S1. As a result of this conversion, a guarantee can also be assigned for the data packet D1 sent from an ethernet component E1 to a TSN component TSN-C. A time guarantee can be assigned by reserving the time window t1 for the TSN stream S1 in each cycle z1, z2.

If the data packet D1 arrives in the TSN network 2 without delay and the associated frame F1 is converted into a TSN stream S1, this can be transmitted in the same cycle z1, z2 in the time window t1 provided for this purpose. With the conversion into a TSN stream S1 and the configuration of an associated time window t1, it is ensured that the data packet D1 as a TSN stream S1 always arrives at the TSN component TSN-C in the time window t1 of a cycle z1, z2. This prevents the data packet D1 from being discarded due to excessive data traffic (e.g. from other TSN components).

As mentioned above with reference to TSN streams D0 and D4, it may be the case for a TSN network “internal” TSN stream that a transmission time is not adhered to. However, this case rarely occurs. In contrast to this, the data packet D1 does not originate from the TSN network 2, but from the surrounding ethernet network 3.

Therefore (in contrast to the TSN streams S0, S4 originating from the TSN network 2), there may be unforeseeable delays before the frame F1 with the data packet D1 reaches the TSN network 2, as shown in FIG. 3. Although the data packet D1 can be converted into a TSN stream S1, it can no longer be classified in the current cycle z1 in the time window t1 provided. There is therefore no guarantee for the time window t1 in the current cycle z1. However, a guarantee is therefore assigned for the time window t1 in the next cycle z2. The sending of F1 in the ethernet network 3 is therefore advantageously placed at the beginning of the cycle z1, z2, if possible, and the reserved time window t1 in the TSN network 2, if possible, at the end of the cycle z1, z2. This ensures that a large proportion of the data packets D0, D4 still reach their destination within the same cycle z1, z2.

For the second cycle z2, a jitter is indicated by the later start of the frame F1 on the ethernet component E1. This means that the frame F1 arrives even later in the following cycle. The jitter is caused by an inaccurate transmission time on the ethernet component and individual forwarding delays (for example due to other frames) at each bridge along the communication link over which the frame F1 is routed. Analogously to the first cycle z1, no guarantee for the time window t1 is possible in the second cycle z2 either, which is why a guarantee is assigned for the time window t1 in the following cycle (not shown).

It may be the case that the data packet D1 no longer reaches the TSN network 2 in the current cycle z1, z2 and two data packets D1, the delayed and the current one, arrive in the following cycle and the associated frame F1 is converted into a TSN stream S1. However, since the time window t1 is only sized for one data packet D1, only one data packet D1 can be forwarded to the TSN component TSN-C. The second data packet D1 must wait in the memory of the TSN bridge TSN-F until a following cycle. This one cycle delay continues, because the “old” data packet D1 in the memory is always sent before the current data packet D1. To remedy this, the memory can be emptied in the current cycle z1, z2 (or every few cycles), for example by sending all data packets D1 to the TSN network 2 in frames instead of TSN streams over a specified period of time with “best effort,” or by simply deleting the memory and thus discarding the old frame. In larger mixed networks 1, in which a plurality of data packets are sent in a time window t1, the time window can be enlarged by the size of a data packet, so that such an error can be corrected per cycle z1, z2.

If, in the mixed network 1, a further (ethernet) component Ey (not shown in the drawings), for example a printer, were to send a further frame Fy (without conversion into a TSN stream) via the TSN component TSN-F to the TSN component TSN-C during a time window t0, t1, t2, the configuration of the TSN network 2 ensures that the said further frame Fy is “held back” until the time window t0, t1 t2 has expired and is only forwarded after the time window t0, t1, t2 has expired. The respective time windows t0, t1, t2 are thus each reserved exclusively for a TSN stream S0, S1, S4, regardless of whether the TSN stream S0, S1, S4 is sent at all. If the time windows t0, t1, t2 are lined up as shown in FIG. 3, the further frame Fy sent from the further ethernet component Ey must wait until all time windows t0, t1, t2 have expired. However, if there is enough bandwidth on the communication link between the TSN component TSN-F and the TSN component TSN-C for the further frame Fy and no time window t0, t1, t2 is reserved, then the further frame Fy is immediately forwarded to the TSN component TSN-C. However, this forwarding is not guaranteed, especially if additional data traffic occurs on the TSN component TSN-F.

A TSN stream S1 uses virtual ethernet multicast receiver addresses, which are correctly interpreted in the TSN network 2, and can thus be sent to the respective TSN component TSN-A, TSN-C, TSN-F as a receiver in the TSN network 2. It is possible to transmit a TSN stream S1 from the TSN network 2 to the ethernet network 3, wherein the TSN stream S1 would be sent to each ethernet component E1, E2, E3 in the ethernet network 3 if a multicast address is used. This is usually not desired, since it also requires a high bandwidth. It may also be the case that an ethernet component E1, E2, E3 cannot receive multicast messages correctly at all. It could also be the case that an ethernet component E1, E2, E3 receives all multicast messages and then “breaks down” under the load. The TSN stream S1 is therefore advantageously converted into a frame F1 when it leaves the TSN network 2, wherein its TSN header is replaced by an ethernet header. This means that preferably only the (single) target address and a VLAN tag are rewritten accordingly. The VLAN tag can also be deleted if it is not needed for any other purpose.

The embodiment shown describes the use of a TSN stream S1 for the permanent, cyclic exchange of a data packet D1. In the TSN network 2, however, other, non-cyclic applications of TSN streams, even temporary TSN streams, are fundamentally also possible. For example, in the event of a (larger) print job, a TSN stream with a bandwidth guarantee could be created between a TSN field device and a TSN printer, which is then dismantled again. If a plurality of TSN streams are active on a TSN bridge, the TSN network 2 maintains all assigned guarantees at the same time.

1. A method for transmitting a, preferably cyclic, data packet from an ethernet component, which is arranged in an ethernet network within a mixed network, to a TSN component, which is arranged in an industrial communication network configured according to the standards of the IEEE 802.1 TSN working group within the mixed network, wherein at least one guarantee defined in the standards of the IEEE 802.1 TSN working group is assigned for the data packet in that a frame which contains the data packet is identified in the industrial communication network configured according to the standards of the IEEE 802.1 TSN working group by a TSN bridge and converted into a TSN stream which contains the data packet, and the data packet is transmitted to the TSN component in the TSN stream,
wherein, when the frame is converted into the TSN stream, an Ethernet header of the frame is replaced by the TSN header, and
wherein, as a result of the conversion, a TSN guarantee is assigned for the data packet sent from the Ethernet component to the TSN component.

2. The method according to claim 1, wherein when the frame arrives in the industrial communication network configured according to the standards of the IEEE 802.1 TSN working group, it is identified by a TSN edge bridge, converted into the TSN stream and transmitted to the TSN component.

3. The method according to either claim 1, wherein the frame is identified according to the IEEE 802.1CB standard.

4. (canceled)

5. The method according to claim 1, wherein the ethernet header of the frame is replaced by the TSN header by means of a retagging function according to the IEEE 802.1Qci standard.

6. The method according to claim 1, wherein a minimum bandwidth of the TSN stream is assigned as a guarantee.

7. The method according to claim 1, wherein a maximum latency of the TSN stream is assigned as a guarantee.

8. The method according to claim 1, wherein a defined burst capability of the TSN stream is assigned as a guarantee.

9. The method according to claim 1, wherein a defined reception time of the TSN stream is assigned as a guarantee, preferably the TSN stream is transmitted to the TSN component in a specified time window of at least one cycle.

10. The method according to claim 1, wherein when a data packet is transmitted from the TSN component located in the industrial communication network configured according to the standards of the IEEE 802.1 TSN working group to an ethernet component located in the ethernet network outside of the industrial communication network configured according to the standards of the IEEE 802.1 TSN working group, a TSN stream which contains the data packet is converted by a TSN bridge into a frame which contains the data packet, and the data packet is transmitted in the frame to the ethernet component.

11. The method according to claim 10, wherein when the TSN stream is converted into the frame, the TSN header of the TSN stream is replaced by an ethernet header, preferably by means of a retagging function according to the IEEE 802.1Qci standard.

12. The method according to claim 10, wherein the VLAN tag of the TSN header of the TSN stream is deleted when the TSN stream is converted into the frame.

13. The method according to claim 10, wherein when the TSN stream is converted into the frame, the TSN header of the TSN stream is used for the frame.

14. The method according to claim 10, characterized in that when leaving the industrial communication network configured according to the standards of the IEEE 802.1 TSN working group, the TSN stream is converted by a TSN edge bridge into the frame which contains the data packet.

15. The mixed network comprising an ethernet network with a number of ethernet components and an industrial communication network configured according to the standards of the IEEE 802.1 TSN working group with at least one TSN component and a TSN bridge, wherein the TSN bridge is configured to identify a frame, which contains a preferably cyclic data packet to be transmitted from an ethernet component to a TSN component, to convert it into a TSN stream which contains the data packet, and to transmit the data packet in the TSN stream to the TSN component in order to assign at least one guarantee for the data packet as defined in the standards of the IEEE 802.1 TSN working group,
wherein the TSN bridge is designed to replace an Ethernet header of the frame with a TSN header when the frame is converted into the TSN stream, and
wherein, as a result of the conversion, a TSN guarantee is assigned for the data packet sent from the Ethernet component to the TSN component.
